(19) United States
(12) Patent Application Publication
(10) Pub. No.: US 2012/0116661 A1
(43) Pub. Date: May 10, 2012

(54) System and Method For Correlation of Vehicles and Drivers

(76) Inventor: Gil Mizrachi, Even Yehuda (IL)

(21) Appl. No.: 12/941,360

(22) Filed: Nov. 8, 2010

(51) Int. Cl. G06F 15/16; G06F 17/00

(52) U.S. Cl. 701/300; 709/203

(57) ABSTRACT

A system and method are provided for correlating between vehicle identification information and driver contact information. This is implemented in a preferred embodiment by means of a database running on a server, which contains tables of data on vehicles and drivers thereof, such as the vehicle license plate numbers and driver cellular phone numbers. By means of the system a user, knowing only the driver's license plate number, can contact this driver.

### BACKGROUND

1. Technical Field

Embodiments of the present invention relate generally to methods using a database of driver contact information and vehicle identification information to allow users to contact drivers by cellphone or other means, using the drivers' license plate number for identification.

2. Description of Related Art

During an ordinary drive there may arise a number of reasons for one driver to desire to communicate with another—for instance if one wants to buy another's car, to lodge a complaint, to meet socially, etc.

Hence, a method for providing driver contact information given vehicle identification information is still a long felt need.

### BRIEF SUMMARY

According to an aspect of the present invention, there is provided a system and method for correlating between vehicle identification information and driver contact information. This may be implemented by means of a database running on a server, which contains tables containing data on vehicles and drivers thereof, such as the vehicle license plate number, and driver cellular phone number.

An aspect of the present invention provides a communications system adapted for allowing communication between a user and a driver consisting of:
a. a database adapted to store correlations between driver contact information and vehicle identification information,
b. a server in electronic communication with said database;
c. inward contacting means adapted to allow contact between said user and said server;
d. outward contacting means adapted to provide contact between said driver and said server;
whereby the user is allowed contact with the driver through the inward and outward contacting means.

It is further within provision of the invention that the aforementioned inward contacting means is selected from the group consisting of: SMS, email, web page, voice call, satellite phone, and instant message.

It is further within provision of the invention that the aforementioned outward contacting means is selected from the group consisting of: SMS, email, web page, voice call, satellite phone, and instant message.

It is within provision of the invention he system of claim 1 where said vehicle identification information is selected from the group consisting of: vehicle registration plate number, vehicle make, model, year, color, and physical description.

It is within provision of the invention that said driver contact information be selected from the group consisting of: cellular phone number, telephone number, email address, social network ID, network telephony ID, physical address, place of employment, spouse information, next of kin, driver's license number, and blood type.

It is within provision of the invention that the server be in electronic communication with a computer network selected from the group consisting of: local area network, wide area network, and internet.

It is within the scope of the invention to provide a method adapted for facilitating communication between a user and a driver consisting of:
a. generating a database storing correlations between driver contact information and vehicle identification information, said database being in electronic communication with a server;
b. contacting said server by said user, by means of inward contacting means;
c. contacting said driver by said server, by means of outward contacting means;
whereby said driver and said user are placed in contact through said server.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a system diagram including communications of the invention;

FIG. 2 illustrates an exemplary database of the invention;

FIG. 3 illustrates an exemplary profile database of the invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a license-phone correlating system.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1,5, or 10).

The term ‘vehicle identification information’ refers hereinafter to any information that can potentially be used to identify a vehicle such as the vehicle registration plate number, vehicle make, model, year, color, physical description, and the like.

The term ‘contact information’ refers hereinafter to any information that can potentially be used to contact a person including cellular phone number, satellite phone number, telephone number, email address, social network ID, network telephony ID, physical address, place of employment, spouse information, next of kin, driver's license number, blood type and the like.

The term ‘vehicle registration plate number’, ‘license plate’, ‘registration plate’, and ‘vehicle tag’ refer to a metal or plastic plate attached to a motor vehicle or trailer for official identification purposes.

According to an aspect of the present invention, there is provided a system and method for correlating between vehicle identification information and driver contact information. This is in a preferred embodiment of the invention implemented by means of a database running on a server, which contains tables containing vehicle identification information and contact information for the drivers thereof. The vehicle identification information may include such data as the license number, vehicle make, model, year, color, physical description, and the like, while the driver contact information may include such data as cellular phone number, telephone number, email address, social network ID, network telephony ID, physical address, place of employment, spouse information, next of kin, driver's license number, blood type and the like. This database preferably allows for vehicles having multiple drivers, by providing for multiple sets of driver contact information for each vehicle, and likewise allows for drivers having multiple vehicles, by providing for multiple sets of vehicle identification information for each driver.

A number of methods may be used to gather the information in such a database. For example the system may allow drivers to voluntarily submit their contact information to a server allowing for such data entry. The correlation between vehicle license information and driver contact information is usually known to various government agencies, which may be interested in making portions of this information known to the public or private industry, either for free or sale. The necessary correlations may be made from publicly accessible data from different sources, such as public motor vehicle registration records and public phone records. Finally, more sophisticated methods may be employed such as using cell tower timing information in conjunction with automated (or manual) vehicle identification systems; for example a traffic camera with suitable software maybe placed next to a cell tower and adapted to photograph and record license plate numbers. These license numbers are then correlated with the cell tower information of which cellular phones have passed into the tower's range. Several such lists may be constructed, either at different times at the same tower, at different towers, or both. Now by finding elements common to several sets of such lists, individual correlations between vehicles and cell numbers can be determined.

Once such a database has been constructed, one may allow access to the information contained therein in a number of ways. For example, one may use the database as a sort of switchboard to allow drivers to contact other drivers indirectly, without revealing the contact information. This may be done for instance by relaying a telephone call from one party to another, by relaying an SMS, relaying an email, or the like. By this means the contact information of one or both parties may be kept confidential.

Communication with the database may also be accomplished in a number of ways, for example by computer (e.g. through a website), by SMS, email, voice call, satellite phone, or the like.

As a concrete example let us imagine a pedestrian who has had his shopping bags stolen by a moped driver. The pedestrian takes note of the moped license number, for instance ‘KRK-492’. Then he sends an SMS in a certain predetermined format to a telephone number associated with the system, for instance ‘Return my bags you cad@KRK-492’. The system, upon receiving an SMS in this format, will send the first part of the message to the driver associated with the moped. In the case of multiple drivers being associated with a given vehicle, the message may for instance be sent to all drivers of the vehicle. Similarly the system has provision for sending messages to multiple vehicles, useful for example in the case of fleets of vehicles.

It is within provision of the invention that software be provided running on a user's cellular phone or other portable device. Such software may be adapted for instance to allow the user to take a picture of a vehicle with his cellphone or portable device, and to automatically recognize the license or other identification information of the vehicle. It is within provision of the invention that this information then be made available for use by the remainder of the system (for purposes of obtaining contact information, sending messages, or the like).

As a second example let us imagine that a peripatetic Karmann Ghia collector has spotted a perfectly preserved black Karmann Ghia convertible and has noted the license information. The collector, desiring to add the specimen to his collection, may now access a webpage associated with the system of the invention, enter the license information of the vehicle in question, and are then allowed to send an email to the owner of the vehicle, either with or without the contact information of the vehicle owner being revealed to the collector.

As a third example let us imagine that a government body has decided to use this system to alert drivers immediately of remotely-observed traffic violations or tolls levied. It is common today for toll roads to levy charges automatically by means of cameras and license plate recognition software, which send bills for instance to the address associated with the car driver. The database of the invention allows further communication, for instance by allowing the toll road operating software to send an SMS to the driver's phone informing him of a fee. Another similar example would be to send an SMS to driver and/or car owner informing him of traffic violations, which may be similarly observed by an automatic system that (for instance) measures vehicle speed and issues tickets automatically to any vehicle exceeding a certain threshold. This may be useful (for instance) in the case of a parent who allows a child to drive his/her car, but want to be instantly updated of any traffic violations.

As a fourth example let us imagine one car has cut off another in a daring and dangerous display of driving machismo. The offended driver decides to contact the offending driver by means of the system, in this example by using his/her cellular phone to dial a telephone number associated with the system, and saying or typing the license number of the offending vehicle. Once the system has recorded the license information of the vehicle to be contacted, a menu of options may be presented to the dialer such as ‘1. send SMS, 2. Send email, 3. Voice call, 4. Report traffic violation.’ The offended driver chooses option 3, and a voice call is patched between the offended driver and the offending driver, by means that will be clear to one skilled in the art of VOIP telephony.

In this latter example we have shown one possible way that various contact options may be selected; namely, by means of a telephone menu system. Other systems for contacting the system, such as computer network, SMS messaging, voice commands, and the like will have their own methods for communication with the system as will be described in the following.

One further way to contact the system is by direct dialing of the license tag number. This may be used with an auxiliary symbol such as ‘*’ or ‘#’ to distinguish the license tag number from a telephone number, or may be used without such an auxiliary symbol. By so dialing, the user is put into direct contact either with the system or with the driver of the vehicle carrying the tag dialed. The number so dialed, either with or without auxiliary symbol, may be called the ‘vehicle identification phone number’.

In the case of SMS message sent to the system, some form of code may be employed such as ‘phone KRK-492’ to cause a voice call to be patched to the driver of vehicle KRK-492, or ‘SMS KRK-492 I love you’ to send the message to the driver of vehicle KRK-492, or ‘email KRK-492 u dropped your wallet’ to send the message to the driver of the vehicle.

It is within provision of the invention that a user of the system may actively send his own contact information to a driver. This will be found useful for cases such as one driver interested in buying another drivers car or contacting the other driver socially. In these cases the user may, for example, send a message to the driver containing the user's contact information.

In the case of internet access of the system, conventional and familiar graphical user interface items such as buttons, check boxes and menus may be presented allowing the user to enter the vehicle information and choose between various contact options such as SMS, email, voice mail, voice call, satellite phone call, social network message, or the like. As will be appreciated by those skilled in the art, the navigation of various menus over the telephone may be accomplished by pressing keys on a numeric keypad, by voice (where the system uses voice recognition means), or other means as will be clear to one skilled in the art.

In the case of telephonic access to the system, a menu system may be employed as described above to allow for the different contact options including but not limited to SMS messaging, voice call, email message, voice mail, or the like.

GPS information may be correlated with the system for several purposes. One way to use this information is to limit messaging such that it may occur only between users within a certain distance of one another. Another way to use GPS information is to update the system database with position information of users, allowing for other users to take action based on distance information (such as starting to move a pallet onto a loading dock when a delivery truck is within a certain distance of the dock).

Another use for the system is for charging drivers, e.g. for toll road usage or parking space usage. A parking attendant or automatic license plate reader gathers the vehicle identification information, which is then input to the system by one of the various methods listed above, upon which the vehicle's owner or operator may be charged by the toll road operator or parking lot operator for user of the road/parking space.

A further use of the system is to generate driver profiles indicating the wariness or lack thereof of a given driver, based upon the textual or verbal feedback this driver receives from other drivers. Such driver profiles may be used e.g. by insurance companies, the police, or other bodies to take actions such as changing insurance premiums, issuing warnings, etc.

Another example of the utility of the system is for the case when a user causes damage to an unoccupied vehicle, and wishes to contact the vehicle owner in order to settle the insurance claims for the damage. The user contacts the vehicle owner(s) by means of the system, for example sending a message containing contact and insurance information, which the vehicle owner(s) may use to settle the insurance issues.

Another example of the utility of the system is to contact hit and run drivers who may try to escape any consequences of having caused an accident; a witness can obtain contact information for this driver by means of the system.

As will be clear from the previous example, use of the system may also be of interest to law enforcement entities, since their own databases may be limited (due to legal restriction, data-gathering limitations, or the like) and additional information available through the system described herein may be of use for identifying and or contacting drivers by means of vehicle identification. For instance, the vehicle description of the system may be more complete than the cursory description generally contained in vehicle license information databases; the system may record vehicle information such as ‘Green Ford, Model Escort, Year 1996, License IRI-958 to Joseph Youngblatt of cellphone 595-2123, dent on right driver door’. This information may well be more complete than the police records, which may lack one or more fields such as driver cellphone number or detailed vehicle description.

It is within provision of the invention that various information sources be compiled to complete the database described herein. For example, various publicly or privately available databases may be compiled and correlated to fill in as many fields concerning driver contact information and vehicle identification information, as possible. Thus public telephone records may be used to correlate names, addresses, and telephone numbers. Internet sites having license information (such as car enthusiast sites, government databases, vehicle registration sites, car dealer sites, and the like) may be used to correlate owner names and other information with vehicle license information. Car owners may also be induced by means of various incentives to enter their own contact information and vehicle identification information. Such inducements may include free use of the system, credits with which to use the system, coupons for use in establishments or over the network, cash inducements, or the like.

It is within provision of the invention that each user of the system may define a personal profile. In this profile permissions may be defined, for instance permissions allowing or denying access to different contact information. This access may be specified for each piece of information and for each different category of user, the categories being defined for instance by profile information. Thus for example one user may allow her email address to be accessed by any other user of the system who drives a Jaguar and is younger than 50 years of age.

Complex conditions may further be specified for initiation of communications between various users of the system. For example, using the system and auxiliary information gleaned for example from GPS devices, communications may be initiated between users who tend to travel the same routes at the same times, allowing such users the opportunity to form carpools or the like.

Another example of the utility of the system is, for example, allowance for all drivers of a certain type of car to be notified, en masse, of a certain condition. For example if Dodge issues a recall of all Dodge Darts, this recall can be sent in the form of an SMS to all drivers of Dodge Darts, thus avoiding potentially dangerous continued use of the now-recalled Dodge Dart.

As will be clear to one skilled in the art, the system is not restricted to cars alone, but rather may be used with trucks, motorcycles, mopeds, tractors, trailers, and even in principle vehicles with no license such as bicycles. In the latter case, the vehicle description would be use to identify the vehicle, and would thus have to be sufficiently precise to allow for unique identification of the vehicle.

This latter case suggest a further improvement of the system that is within provision of the invention, namely that partial information of different types may be used to identify a vehicle uniquely. For example a partial vehicle license number such as ‘HR?-?94’ (using the wildcard notation wherein the symbol ? represents any character) may be input to the system, in addition to a partial physical vehicle description such as ‘green sports car of recent make’. These two pieces of partial information may be enough to uniquely determine the vehicle, using data mining techniques that will be clear to one skilled in the art. Further information may of course also be used for such purposes, such as daily route generally taken by a given vehicle, vehicle owner address and workplace, and the like.

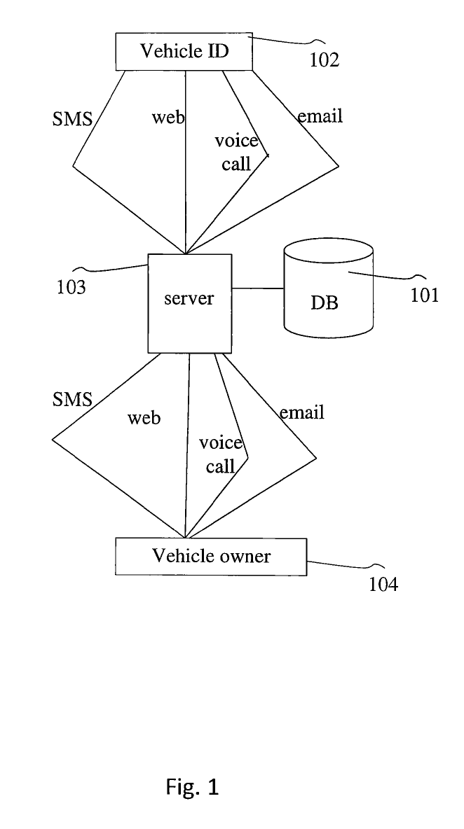

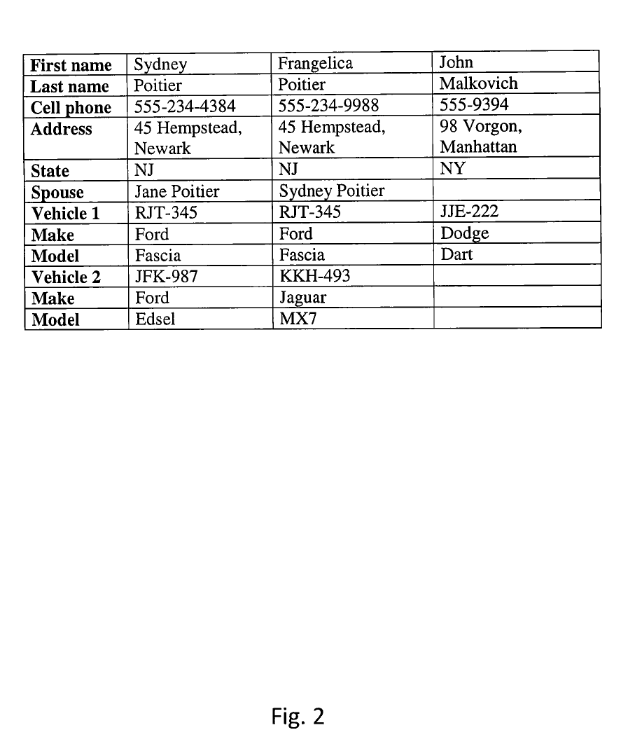

One possible implementation of the system is shown in FIG. 1. Here the vehicle ID is sent as a request by a system user by means of SMS, web, phone call, or email to the server. The server is in communication with database 101 which stores driver contact information and vehicle identification information (as shown for example in FIG. 2). Depending on the type of request sent (which may be a request to patch a call between the user and driver, or may be a request to send an SMS, or the like), the server will take appropriate action (i.e. sending an SMS, patching a phone call between user and driver, or the like). The server may keep the contact information confidential, depending upon the profile of the driver and the setup of the system.

In FIG. 2 an example database is shown containing some of the information relevant to the system described herein. Here various drivers are listed including driver contact information and car identification information. As described above the driver contact information may include cellular phone number, satellite phone number, telephone number, email address, social network ID, network telephony ID, physical address, place of employment, spouse information, next of kin, driver's license number, blood type, and the like, while the vehicle identification information may include the vehicle registration plate number, vehicle make, model, year, color, physical description, and the like.

It is within provision of the invention that the system may actively send information to pairs of users whose profiles contain certain matching parameters. For instance, if two users define profiles which indicate they are interested in dating anyone who lives within a 50 km radius, and the system determines that this condition is fulfilled, then the appropriate contact information will be sent to these users.

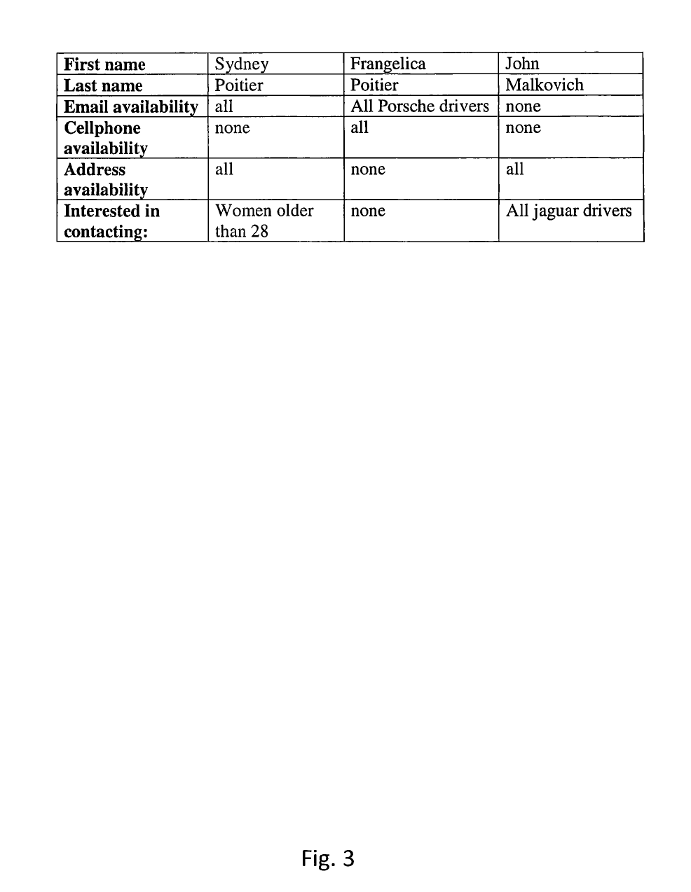

FIG. 3 shows an example of such profile information that may be entered and/or modified by users of the system, allowing them to define who may or may not see a given piece of information, whom they are interested in contacting, and the like. The system may thus arbitrate the contact between users and drivers based on the profile information, for example allowing users to access contact information for certain contacts and denying access for others, or initiating contact between groups of users.

It is within provision of the invention that the database of the system be accessible by various other software entities. Thus (for example) when filling out online forms requiring driver's license information, the driver information can be accessed by form-filling software that is adapted to request such information from the system of the invention and use it to automatically fill in web-based or other forms.

All examples discussed herein are non-limiting examples.

The disclosed embodiments may be variously combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A communications system adapted for allowing communication between a user and a driver consisting of:
a. a database adapted to store correlations between driver contact information and vehicle identification information,
b. a server in electronic communication with said database;
c. inward contacting means adapted to allow contact between said user and said server;
d. outward contacting means adapted to provide contact between said driver and said server;
whereby said user is allowed contact with said driver through said inward and outward contacting means.

2. The system of claim 1 wherein said inward contacting means is selected from the group consisting of: SMS, email, web page, telephone call to a dedicated system number, telephone call to a vehicle identification phone number, satellite phone call, and instant message.

3. The system of claim 1 wherein said outward contacting means is selected from the group consisting of: SMS, email, web page, telephone call to a dedicated system number, telephone call to a vehicle identification phone number, satellite phone call, instant message.

4. The system of claim 1 where said vehicle identification information is selected from the group consisting of: vehicle registration plate number, vehicle make, model, year, color, and physical description.

5. The system of claim 1 where said driver contact information is selected from the group consisting of: cellular phone number, telephone number, email address, social network ID, network telephony ID, physical address, place of employment, spouse information, next of kin, and driver's license number, and blood type.

6. The system of claim 1 wherein said server is in electronic communication with a computer network selected from the group consisting of: local area network, wide area network, internet.

7. The system of claim 1 further providing GPS positioning information of said user's position and said driver's position, wherein said server is adapted to limit said contact between said driver and said user when said positions are separated by a distance larger than a predetermined threshold.

8. The system of claim 1 further providing profile information for said user and said driver, and arbitrating said contact between said driver and said user based on said profile information.

9. The system of claim 1 further providing software running on a mobile device belonging to said user adapted to photograph a vehicle and determine said vehicle identification information from said photograph.

10. A method adapted for facilitating communication between a user and a driver consisting of:
a. generating a database storing correlations between driver contact information and vehicle identification information, said database being in electronic communication with a server;
b. contacting said server by said user, by means of inward contacting means;
c. contacting said driver by said server, by means of outward contacting means;
whereby said driver and said user are placed in contact through said server.

11. The method of claim wherein said inward contacting means is selected from the group consisting of: SMS, email, web page, telephone call to a dedicated system telephone number, telephone call to a vehicle identification phone number, satellite phone call, instant message.

12. The method of claim 10 wherein said outward contacting means is selected from the group consisting of: SMS, email, web page, telephone call to a dedicated system telephone number, telephone call to a vehicle identification phone number, satellite phone call, instant message.

13. The method of claim 10 where said vehicle identification information is selected from the group consisting of: vehicle registration plate number, vehicle make, model, year, color, and physical description.

14. The method of claim 10 where said driver contact information is selected from the group consisting of: cellular phone number, telephone number, email address, social network ID, network telephony ID, physical address, place of employment, spouse information, next of kin, next of kin, driver's license number, and blood type.

15. The method of claim 10 wherein said server is in electronic communication with a computer network selected from the group consisting of: local area network, wide area network, internet.

16. The method of claim 10 further providing GPS positioning information of said user's position and said driver's position, wherein said server is adapted to limit said contact between said driver and said user when said positions are separated by a distance larger than a predetermined threshold.

17. The method of claim 10 further providing software running on a mobile device belonging to said user adapted to photograph a vehicle and determine said vehicle identification information from said photograph.

18. The method of claim 10 further providing profile information for said user and said driver, and arbitrating said contact between said driver and said user based on said profile information.
